(19) United States
(12) Patent Application Publication
(10) Pub. No.: US 2013/0264082 A1
(43) Pub. Date: Oct. 10, 2013

(54) JOINTED FOLDING ARM

(71) Applicants: Dennis R. Solbrack, Colfax, WA (US); Christopher E. Wood, Spokane, WA (US)

(72) Inventors: Dennis R. Solbrack, Colfax, WA (US); Christopher E. Wood, Spokane, WA (US)

(21) Appl. No.: 13/827,372

(22) Filed: Mar. 14, 2013

Related U.S. Application Data
(60) Provisional application No. 61/621,147, filed on Apr. 6, 2012.

(51) Int. Cl. A01B 73/06

(52) U.S. Cl. CPC A01B 73/065
USPC 172/667

(57) ABSTRACT

Representative implementations of devices and techniques provide a jointed folding arm assembly. Two or more solid links may be pivotally coupled together to form a jointed folding arm. The jointed arm may be pivotally coupled at one end to a load device. The other end of the jointed arm may be pivotally coupled to a tongue arranged to pull the load device. Further, one or more actuators or cylinders may be coupled to the tongue, the jointed arm, and/or the load device and arranged to fold the load device.

### PRIORITY CLAIM AND CROSS-REFERENCE TO RELATED APPLICATION

This application claims the benefit under 35 U.S.C. §119(e)(1) of U.S. Provisional Application No. 61/621,147, filed Apr. 6, 2012, which is hereby incorporated by reference in its entirety.

### BACKGROUND

Various agricultural implements that are configured for working the soil, for example, may be pulled by a vehicle along varying terrain. To increase the efficiency of each pass, the implements may be constructed to have a wide footprint (or width). In some cases, the wide footprint may be accomplished by coupling multiple implement units together side-by-side. This allows a single pass to accomplish the work of multiple passes.

However convenient the multiple-unit configuration is in the field, it is often less convenient when transporting or storing the multiple-unit implement. In some cases, the width of the multiple-unit implement makes it problematic to transport the implement on the highway. In other cases, finding a storage area to fit the implement is difficult. While some implements may be capable of folding for transport or storage, many of the implements are difficult to fold, or less stable when in a multiple-unit configuration, including when capable of folding.

For example, a multiple-unit implement may be less rigid, and subject to unpredictable behavior when traversing a field having varying terrain. For example, the implement may bow forward when on a decline or bow rearward when on an incline. The implement may also twist to an undesirable degree when traversing other varying terrain types. Further, there may be less control over the implement when pulling a multiple-unit implement.

### BRIEF DESCRIPTION OF THE DRAWINGS

The detailed description is set forth with reference to the accompanying figures. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations and photos of the figures are for example, and others shapes and or dimensions may be used and remain within the scope of the disclosure, unless specified otherwise.

FIG. 1 is a perspective view of a jointed folding arm assembly, as installed on a load device, such as a seed drill, according to one embodiment.

FIG. 2 illustrates several views of an example drawbar link assembly, according to one embodiment.

FIG. 3 illustrates several views of an example box connector, according to one embodiment.

FIG. 4 illustrates a view of the jointed folding arm assembly, in a partially folded position, according to an embodiment.

FIG. 5 illustrates a view of the jointed folding arm assembly, in an extended position, according to an embodiment. The illustration shows both an inboard and an outboard actuator, according to the embodiment.

FIG. 6 illustrates another view of the jointed folding arm assembly, from an opposite side and in an extended position, according to an embodiment.

FIG. 7 illustrates another view of the jointed folding arm assembly, in a fully folded position, according to an embodiment.

### DETAILED DESCRIPTION

### Introduction

Representative implementations of devices and techniques provide an example jointed folding arm, for use in a wide range of agricultural implements, such as a folding seed or grain drill, for example. The jointed folding arm uses two or more solid link sections to provide stability to the foldable implement in an extended position and also provide a folding action for storage and/or transport of the implement. In one embodiment, the jointed folding arm also uses one or more actuators (e.g., hydraulic or pneumatic cylinders, and the like) to control the folding action.

In one aspect, two or more solid link sections may be pivotally coupled together to form a jointed folding arm. The jointed arm may be pivotally coupled at one end to a load device, such as the seed drill, for example. The other end of the jointed arm may be pivotally coupled to a tongue arranged to pull the load device. Further, one or more actuators may be coupled to the tongue, the jointed arm, and/or the load device and arranged to fold the load device.

For example, in an implementation, an apparatus comprises a first solid link pivotally coupled to a tongue 102 of an agricultural implement, and a second solid link pivotally coupled to the first solid link and pivotally coupled to a load device of the agricultural implement. In the implementation, the first solid link and the second solid link are arranged to fold the load device toward the tongue, and are arranged to provide torsional strength to the load device when not folding the load device.

In another implementation, the apparatus includes an inboard actuator coupled to the tongue at a first end of the inboard actuator and coupled to the load device at a second end of the inboard actuator and arranged to fold the load device toward the tongue. In a further implementation, the apparatus includes an outboard actuator coupled to the second solid link at a first end of the outboard actuator and coupled to the load device at a second end of the outboard actuator and arranged to fold the load device toward the tongue.

For example, in an embodiment, the inboard actuator and the outboard actuator are plumbed together and operate opposite to each other, the inboard actuator extending while the outboard actuator contracts and the inboard actuator contracting while the outboard actuator extends.

Various implementations of devices and techniques for a jointed folding arm are discussed in this disclosure. The devices and techniques are discussed with reference to example implementations illustrated in the figures. The devices and techniques discussed herein are referred to in the environment of an overland agriculture implement, such as a seed drill, for ease of discussion and illustrative convenience. The devices and/or techniques may also be used in other environments, with other implementations, and associated with other vehicles, systems, and the like, to provide stability and folding capabilities.

Advantages of the disclosed devices and techniques are varied, and include: 1) assisting in folding the load device for transport or storage; 2) providing torsional strength to the implement during field use; 3) preventing the load device from folding during field use; 4) preserving a correct position (e.g., a straight-line formation) of each unit of the load device while traversing varying terrain; 5) preventing the load device from bowing during decline or incline operation; and 6) assistance in bearing the load of the implement while pulling during field use. Other advantages of the disclosed techniques may also be present.

Techniques and devices are discussed with reference to example seed drill implements and systems illustrated in the figures. However, this is not intended to be limiting, and is for ease of discussion and illustrative convenience. The techniques and devices discussed may be applied to many of various load devices or implement assembly and device designs, and the like, and remain within the scope of the disclosure. In alternate implementations, the load device may be employed in other ways or with other devices, systems, or the like.

Implementations are explained in more detail below using a plurality of examples. Although various implementations and examples are discussed here and below, further implementations and examples may be possible by combining the features and elements of individual implementations and examples.

### Example Jointed Folding Arm

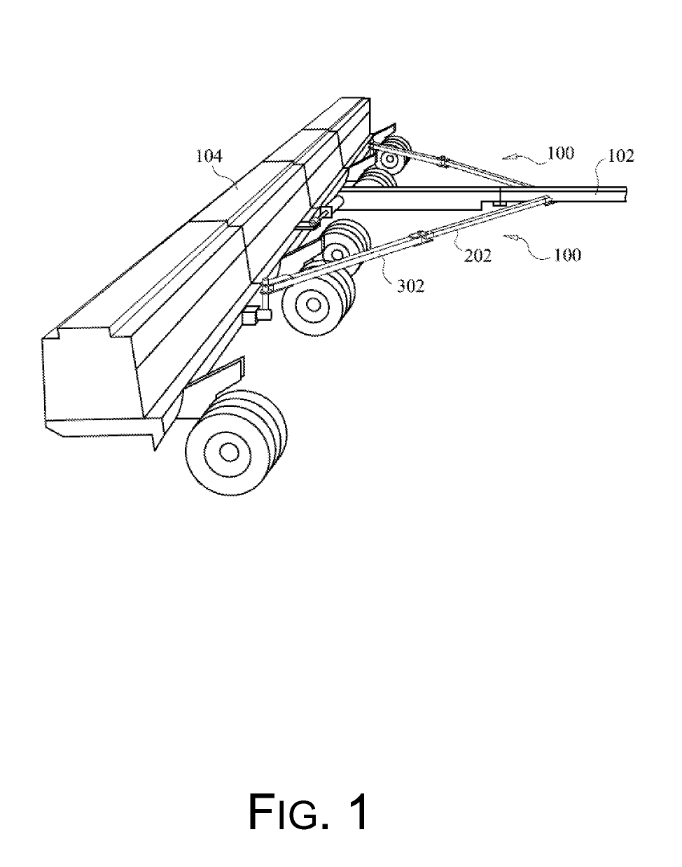

The following description refers to the drawings shown in FIGS. 1-7. Several embodiments of jointed folding arms are described. Descriptions of the embodiments may include examples of materials, types of fabrication, and dimensions. However, the descriptions are for ease of understanding and are not intended to be limiting. Other suitable materials, types of fabrication, and dimensions may be used to construct a jointed folding arm without departing from the scope of this disclosure.

FIG. 1 is a perspective view of a jointed folding arm assembly 100, as installed on a load device 104 (a seed drill is shown as the load device in the illustration), for example, according to one embodiment. The jointed folding arm assembly 100 may be used in and on various mechanical devices and machinery, where an adjustment may be made to a position of one or more components of the load device 104. For example, in the illustration of FIG. 1, two jointed folding arm assemblies 100 are installed on a load device 104 having four boxes or units, and arranged to be pulled behind a vehicle. This is an example application of a jointed folding arm assembly 100 provided for ease of discussion, and is not intended to be limiting.

Since the load device 104 in FIG. 1 has four load device units, it may become useful to reduce the overall size or width of the implement, particularly for storage and/or transport. Consequently, an implement, such as the load device 104, may be arranged to fold at preselected points, resulting in a more compact overall footprint. For example, the load device 104 in FIG. 1 may be arranged to fold at the points between each of the units, or between sets of units (i.e., at the center of the four units, for example).

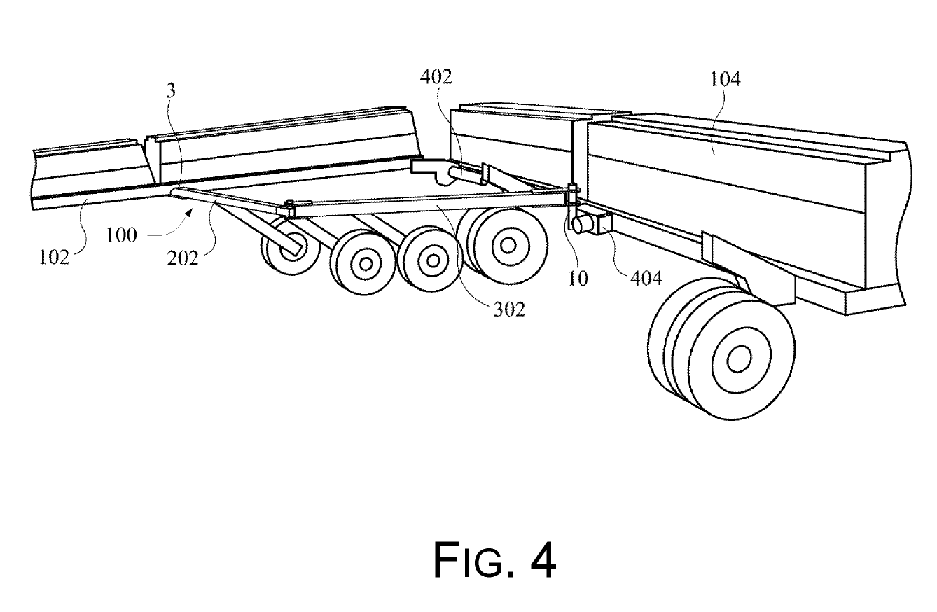

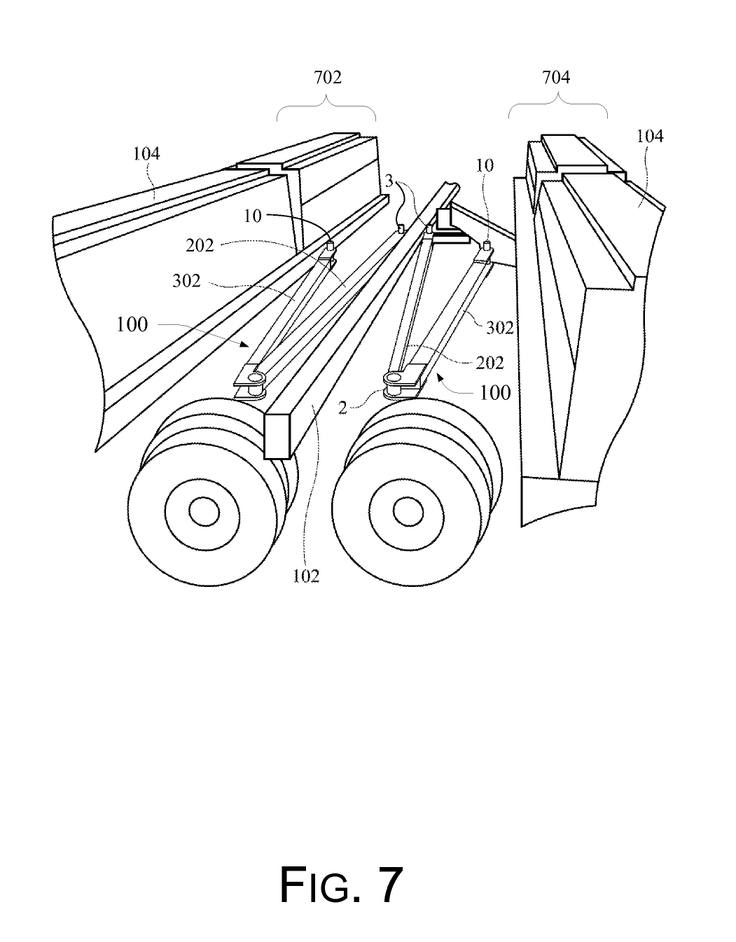

In one implementation (as shown in FIGS. 4 and 7, for example), the load device 104 is arranged to fold at the tongue 102 (e.g., where the tongue 102 meets the load device 104), forming a first load device portion (a left portion) and a second load device portion (a right portion). In the implementation, one jointed folding arm 100 (including a first solid link 202 and a second solid link 302, as shown in FIGS. 1 and 7 and discussed below) is arranged to fold the first load device portion toward the tongue 102 and another jointed folding arm 100 (including a third solid link 202 and a fourth solid link 302, as shown in FIGS. 1 and 7 and discussed below) are arranged to fold the second load device portion toward the tongue 102.

Placement and operation of the jointed folding arms 100 may facilitate the folding action of the implement. Additionally, placement of the jointed folding arm assembly 100 may also provide torsional strength to the implement while in the extended (e.g., unfolded) position. This may be particularly important, considering the hinged, folding nature of the load device 104. For example, when the implement is in the field working, it may be important to have it behave in a stable predictable manner while being pulled behind a farm vehicle. Thus, the torsional strength provided by the jointed folding arm assembly 100 may increase stability and predictability.

The illustration of FIG. 1 shows an example jointed folding arm assembly 100 including an example drawbar link assembly 202 and an example box connector 302. In various implementations, the drawbar link assembly 202 and the box connector 302 are solid links (e.g., solid struts, supports, bars, braces, crosspieces, beams, etc.). In an implementation, the drawbar link assembly 202 and the box connector 302 are arranged to fold the load device 104 toward the tongue 102, and are arranged to provide torsional strength to the load device 104 when not folding the load device 104. In alternate implementations, additional or alternate components may be used to accomplish the techniques described herein.

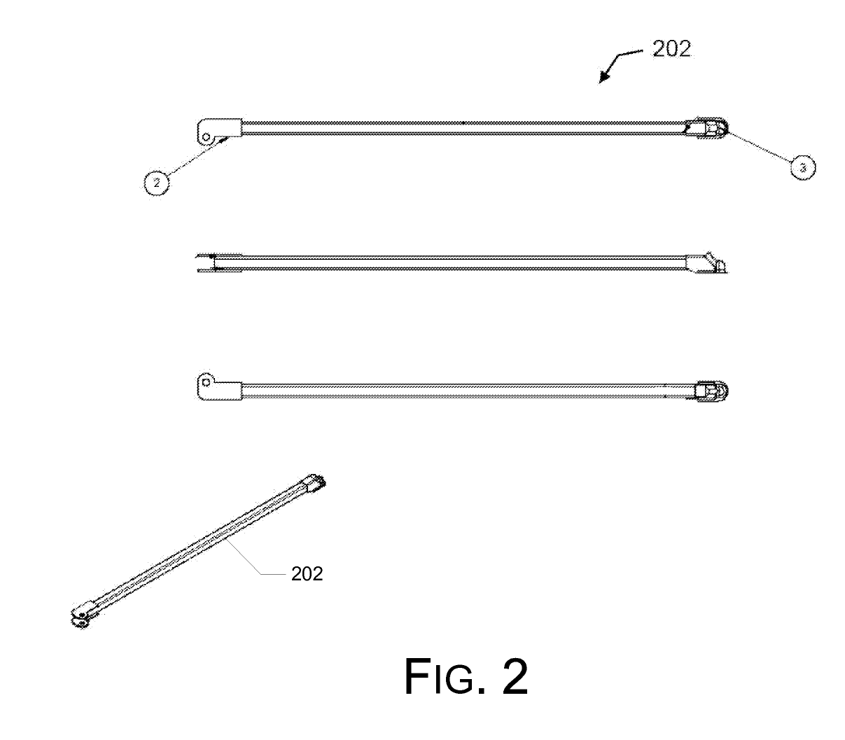

In one embodiment, as shown in FIG. 1 a first end of the drawbar link assembly 202 is pivotally coupled to the tongue 102 of the implement. In an embodiment, the first end of the drawbar link assembly 202 has three degrees of freedom of movement at the point where it is coupled to the tongue 102 (e.g., pitch, yaw, and roll). In other embodiments, the first end of the drawbar link assembly 202 may have fewer degrees of freedom, or different degrees of freedom. In an embodiment, the second end of the drawbar link assembly 202 is pivotally coupled to the box connector 302 via a hinge 2 (as shown in FIG. 2).

In an embodiment, as shown in FIG. 1, a first end of the box connector 302 is pivotally coupled to the second end of the drawbar link assembly 202 via the hinge 2. The second end of the box connector 302 is pivotally coupled to the load device 104 (i.e., one or more of the units (i.e., boxes) of the load device 104, for example).

In various implementations, as shown in FIG. 1, multiple jointed folding arms 100 may be used with a load device 104 of an implement. As shown in FIG. 1, a jointed folding arm 100 may be used on both sides (e.g., the left side and the right side) of the tongue 102 and on both sides of the load device 104, for example. Accordingly, such implementations may include a second drawbar link assembly 202, a second box connector 302, as well as corresponding hinges, connectors, actuators, and the like, as discussed below. In alternate implementations, an implement may employ more than two jointed folding arm 100 assemblies with one or more load device(s) 104. For the purposes of this disclosure, any discussion of components or features of a single jointed folding arm 100 assembly also may apply to any additional jointed folding arm 100 assemblies used with an implement or load device 104.

FIG. 2 illustrates several views of an example drawbar link assembly 202, according to one embodiment. At the first end of the drawbar link assembly 202 is a ball joint 3, arranged to couple the drawbar link assembly 202 to the tongue 102 of the implement. In an implementation, the ball joint 3 provides the three degrees of freedom of movement mentioned above. At the second end of the drawbar link assembly 202 is half of a hinge 2, arranged to couple the drawbar link assembly 202 to the box connector 302.

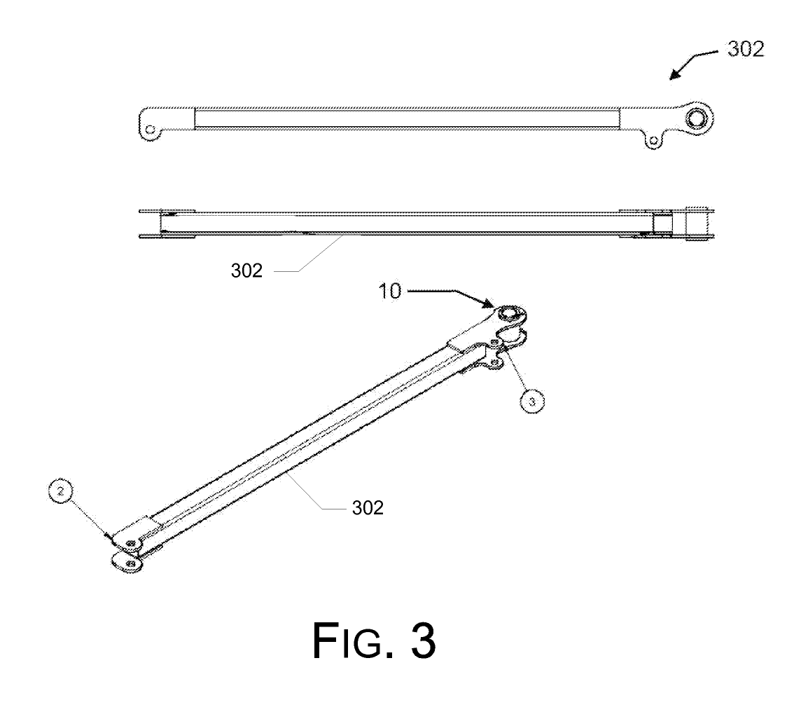

FIG. 3 illustrates several views of an example box connector 302, according to one embodiment. At the first end of the box connector 302 is another half of a hinge 2, arranged to couple the box connector 302 to the drawbar link assembly 202. At the second end of the box connector 302 is a pivot 10, arranged to couple the box connector 302 to the load device 104. In one implementation, the pivot 10 is coupled to a joint between boxes of the load device 104. In another implementation, the pivot 10 is coupled to one of the boxes of the load device 104.

FIG. 4 illustrates a view of the jointed folding arm assembly 100, in a partially folded position, according to an embodiment. In the partially folded position, the jointed folding arm assembly 100 pivots at least at the joints 2, 3, and 10. In one embodiment, the jointed folding arm assembly 100 folds with the hinge 2 outward from the implement, as shown in FIG. 4. In the embodiment, as shown in FIG. 4, the drawbar link assembly 202 and the box connector 302 are arranged to fold away from the load device 104 while folding the load device 104 toward the tongue 102.

In an embodiment, as shown in FIG. 4, the jointed folding arm assembly 100 includes one or more actuators 402, 404. For example, the jointed folding arm assembly 100 may include an inboard actuator 402 arranged to pull the load device 104 into a folded position and/or push the load device 104 into an extended (e.g., field, working, etc.) position.

In various embodiments, as shown in FIG. 4, the inboard actuator 402 may be pivotally attached at one end to the load device 104 (or one or more boxes of the load device 104) and pivotally attached at the other end to the tongue 102 of the implement. In that configuration, the inboard actuator 402 may pull the load device 104 towards the tongue 102 to fold the load device 104, or push the load device 104 away from the tongue 102 to extend the load device 104.

In an alternate embodiment, the inboard actuator 402 may be pivotally attached at one end to one unit (i.e., box) of the load device 104 and pivotally attached at the other end to another unit of the load device 104, where the actuator 402 spans between the units. In that configuration, the inboard actuator 402 may pull the units together to fold the load device 104, or push the units apart to extend the load device 104.

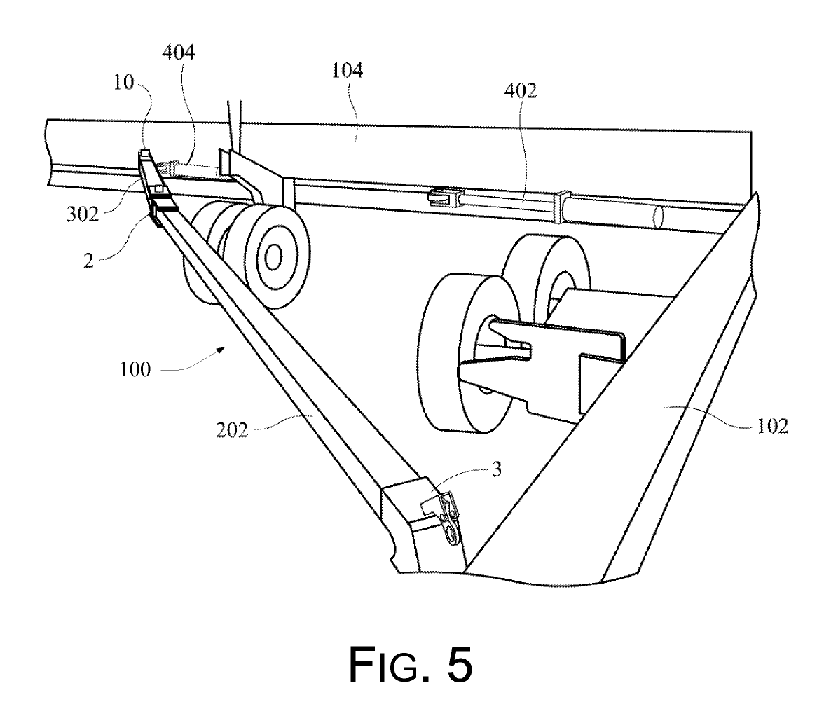

In a further embodiment, as shown in FIGS. 4 and 5, the jointed folding arm assembly 100 includes an outboard actuator 404. In an example embodiment, the outboard actuator 404 assists the inboard actuator 402 in pulling the load device 104 toward the tongue 102, into a folded position and/or pushing the load device 104 (e.g., units of the load device 104) away from the tongue 102 into an extended position.

In one embodiment, as shown in FIG. 5, the outboard actuator 404 is pivotally attached at one end to the load device 104 and pivotally attached at the other end to the box connector 302. For example, in one implementation, the outboard actuator 404 is pivotally attached to the pivot 10 at the second end of the box connector 302. In that configuration, the actuator 404 not only helps move the load device 104 into a folded position, but may also guide the box connector 302, folding the jointed folding arm 100 with the hinge 2 outward, as mentioned above.

In alternate embodiments, the actuators 402 and 404 may be plumbed separately and controlled separately or they may be plumbed together and controlled together. In one example, the actuators operate in an opposite manner, with one actuator 402, 404 extending while the other actuator 402, 404 is contracting, during folding or extending the load device 104. For instance, during folding the load device 104, inboard actuator 402 may be contracting while outboard actuator 404 is extending. Conversely, during extending of the load device 104, inboard actuator 402 may be extending while outboard actuator 404 is contracting.

In various implementations, the actuators 402, 404 may include hydraulic, pneumatic, electric, etc. actuators or cylinders, arranged to have a capability of pulling and/or pushing a load such as the load device 104.

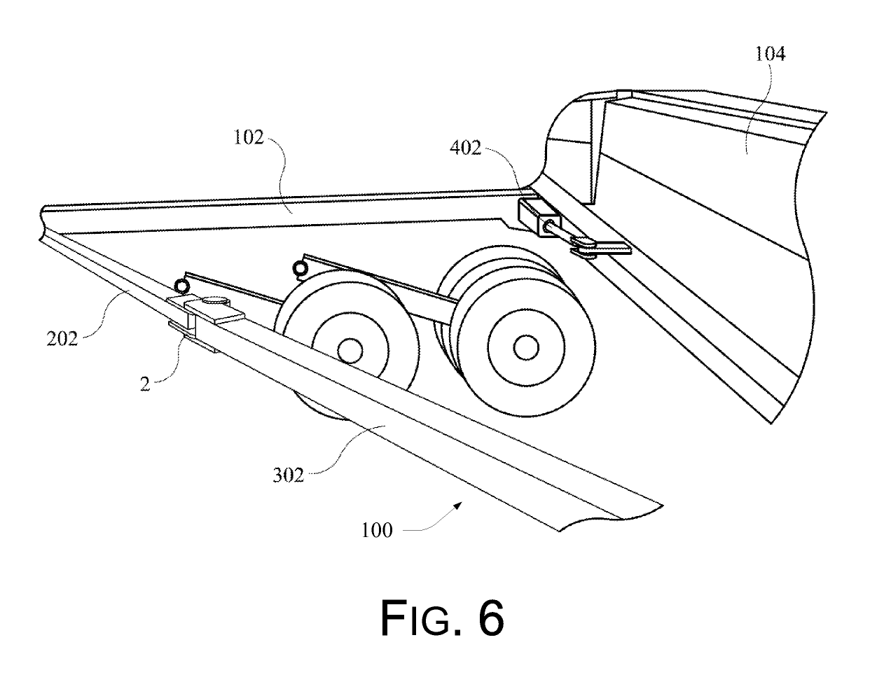

FIGS. 5 and 6 illustrate views of the jointed folding arm assembly 100, in an extended position, from each side of the implement or load device 104, according to various embodiments. In the extended position, the jointed folding arm(s) 100 may provide torsional strength to the load device 104, as described above. In an implementation, one or more of the actuators 402 and 404 may also add to the torsional strength, either by holding the units of the load device 104 in the desired extended position, holding the jointed folding arm(s) 100 in an extended position, or both functions.

In an implementation, the drawbar link assembly 202 and the box connector 302 comprising the jointed folding arm 100 (either on one side or on both sides of the load device 104) form a stiff brace when not folding the load device 104. For example, the one or more jointed folding arms 100, when forming a stiff brace, may be arranged to prevent the load device 104 from folding when traversing varying terrain. For instance, when traversing a decline in the terrain, a load device 104 may have a tendency to roll forward at each end, and particularly at the connection points or hinges of the multiple units of the load device 104 (if so equipped). Likewise, a load device 104 may have a tendency to bow rearward when traversing an incline in the terrain. In an embodiment, the stiff brace(s) formed by the jointed folding arm(s) 100 prevent or reduce the forward or rearward bowing.

In an implementation, the stiff brace(s) formed by the jointed folding arm(s) 100 are arranged to maintain the load device 104 in a substantially straight-line formation when traversing varying terrain. For example, the substantially straight-line formation may be at a predetermined angle with respect to the tongue 102. In one implementation, the substantially straight-line formation of the load device 104 is perpendicular (i.e., as near to perpendicular as practical) to the tongue 102. In alternate implementations, the substantially straight-line formation of the load device 104 is at some other angle with respect to the tongue 102.

In another implementation, the stiff brace(s) formed by the jointed folding arm(s) 100 are arranged to pull the load device 104 over varying terrain, and to bear a load of the load device 104 over the varying terrain. Accordingly, in the implementation, the materials, construction, connectors, hinges, and the like are formed using industry accepted standards to allow the stiff brace(s) formed by the jointed folding arm(s) 100 to bear the load of the load device 104.

In various implementations, as shown in FIGS. 5 and 6, the drawbar link assemblies 202 on either side of the tongue 102 may be coupled to the tongue 102 opposite to each other. In one embodiment, as shown in FIGS. 5 and 6, each side of the tongue 102 may include an inboard actuator 402 coupled to the tongue 102 at one end of the actuator 202, and coupled to the load device 104 at the other end of the actuator 202. Also, as shown in FIG. 5 (not shown in FIG. 6), in an embodiment, each end of the load device 104 may include an outboard actuator 404 coupled to the load device at one end of the actuator 404 and coupled to a box connector 302 at the other end of the actuator 302.

FIG. 7 illustrates another view of the jointed folding arm assembly 100, in a fully folded position, according to an embodiment. In an embodiment, the ball joint 3 maintains its location with respect to the tongue 102 during folding or unfolding (i.e., extending) of the load device 104. In various implementations, the ball joint 3 has freedom to pivot in various directions, while maintaining its location, during folding and/or unfolding.

As shown in the illustration, with the load device 104 fully folded, the jointed folding arm assembly 100 is also in a folded configuration, with the hinge 2 forward of the ball joint 3 (the front of the implement is in the foreground of the illustration of FIG. 7). In various implementations, the jointed folding arm assembly 100 is folded such that the drawbar link assembly 202 and the box connector 302 have a small angle between them at the hinge 2. In that configuration, the folded implement can have an optimally reduced footprint.

For example, in the example embodiment shown in FIG. 7, the load device 104 is arranged to fold at the tongue 102, forming a first load device portion 702 (a left portion) and a second load device portion 704 (a right portion). In the embodiment, the first solid link 202 and the second solid link 302 are arranged to fold the first load device portion 702 (the left portion) toward the tongue 102 and the third solid link 202 and the fourth solid link 302 are arranged to fold the second load device portion 704 (the right portion) toward the tongue 102.

In one implementation, as shown in FIG. 7, the first load device portion 702 is approximately parallel to the second load device portion 704 when the load device 104 is fully folded. In alternate implementations, the first load device portion 702 and the second load device portion 704 may form a small angle (e.g., 0 to 10 degrees, or the like) with respect to each other when fully folded.

As discussed above, the techniques, components, and devices described herein with respect to the implementations are not limited to the illustrations of FIGS. 1-7, and may be applied to other jointed folding arm devices, and designs, without departing from the scope of the disclosure. In some cases, additional or alternative components, techniques, sequences, or processes may be used to implement the techniques described herein. Further, the components and/or techniques may be arranged and/or combined in various combinations, while resulting in similar or approximately identical results. It is to be understood that a jointed folding arm assembly 100 may be implemented as a stand-alone device or as part of another system (e.g., integrated with other components, systems, etc.). In various implementations, additional or alternative components may be used to accomplish the disclosed techniques and arrangements.

### Conclusion

While various discreet embodiments have been described throughout, the individual features of the various embodiments may be combined to form other embodiments not specifically described. The embodiments formed by combining the features of described embodiments are also jointed folding arm assemblies.

What is claimed is:

1. An apparatus, comprising:
a first solid link pivotally coupled to a tongue of an agricultural implement;
a second solid link pivotally coupled to the first solid link and pivotally coupled to a load device of the agricultural implement,
wherein the first solid link and the second solid link are arranged to fold the load device toward the tongue, and are arranged to provide torsional strength to the load device when not folding the load device; and
an inboard actuator coupled to the tongue at a first end of the inboard actuator and coupled to the load device at a second end of the inboard actuator and arranged to fold the load device toward the tongue.

2. The apparatus of claim 1, further comprising an outboard actuator coupled to the second solid link at a first end of the outboard actuator and coupled to the load device at a second end of the outboard actuator and arranged to fold the load device toward the tongue.

3. The apparatus of claim 2, wherein the inboard actuator and the outboard actuator are plumbed together and operate opposite to each other, the inboard actuator extending while the outboard actuator contracts and the inboard actuator contracting while the outboard actuator extends.

4. The apparatus of claim 1, further comprising a third solid link pivotally coupled to the tongue of the agricultural implement opposite to the first link, and a fourth solid link pivotally coupled to the third solid link and pivotally coupled to the load device of the agricultural implement, the third solid link and the fourth solid link arranged to fold the load device toward the tongue, and arranged to provide torsional strength to the load device when not folding the load device.

5. The apparatus of claim 4, further comprising a second inboard actuator coupled to the tongue at a first end of the second inboard actuator and coupled to the load device at a second end of the second inboard actuator and arranged to fold the load device toward the tongue, the second inboard actuator coupled to the tongue opposite the inboard actuator.

6. The apparatus of claim 5, further comprising a second outboard actuator coupled to the fourth solid link at a first end of the second outboard actuator and coupled to the load device at a second end of the second outboard actuator and arranged to fold the load device toward the tongue.

7. The apparatus of claim 6, wherein the second inboard actuator and the second outboard actuator are plumbed together and operate opposite to each other, the second inboard actuator extending while the second outboard actuator contracts and the second inboard actuator contracting while the second outboard actuator extends.

8. The apparatus of claim 4, wherein the first solid link and the second solid link are arranged to comprise a stiff brace when not folding the load device and/or the third solid link and the fourth solid link are arranged to comprise another stiff brace when not folding the load device.

9. The apparatus of claim 8, wherein the stiff brace and/or the other stiff brace is arranged to prevent the load device from folding when traversing varying terrain.

10. The apparatus of claim 8, wherein the stiff brace and/or the other stiff brace is arranged to maintain the load device in a substantially straight-line formation when traversing varying terrain, the substantially straight-line formation being at a predetermined angle with respect to the tongue.

11. The apparatus of claim 8, wherein the stiff brace and/or the other stiff brace is arranged to maintain the load device in a substantially straight-line formation when traversing varying terrain, the substantially straight-line formation being perpendicular to the tongue.

12. The apparatus of claim 8, wherein the stiff brace and/or the other stiff brace is arranged to pull the load device over varying terrain, the stiff brace and/or the other stiff brace arranged to bear a load of the load device over the varying terrain.

13. The apparatus of claim 1, wherein the first solid link and the second solid link are arranged to fold away from the load device while folding the load device toward the tongue.

14. The apparatus of claim 4, wherein the load device is arranged to fold at the tongue, forming a first load device portion and a second load device portion, and wherein the first solid link and the second solid link are arranged to fold the first load device portion toward the tongue and the third solid link and the fourth solid link are arranged to fold the second load device portion toward the tongue.

15. The apparatus of claim 14, wherein the first load device portion is approximately parallel to the second load device portion when the load device is fully folded.

16. An apparatus, comprising:
a first solid link pivotally coupled to a tongue of an agricultural implement;
a second solid link pivotally coupled to the first solid link and pivotally coupled to a load device of the agricultural implement, the first solid link and the second solid link arranged to fold the load device toward the tongue, and arranged to provide torsional strength to the load device when not folding the load device;
a third solid link pivotally coupled to the tongue of the agricultural implement opposite to the first link;
a fourth solid link pivotally coupled to the third solid link and pivotally coupled to the load device, the third solid link and the fourth solid link arranged to fold the load device toward the tongue, and arranged to provide torsional strength to the load device when not folding the load device;
a first inboard actuator coupled to the tongue at a first end of the first actuator and coupled to the load device at a second end of the first inboard actuator;
a first outboard actuator coupled to the second solid link at a first end of the first outboard actuator and coupled to the load device at a second end of the first outboard actuator, the first inboard actuator and the first outboard actuator arranged to fold a first portion of the load device toward the tongue;
a second inboard actuator coupled to the tongue at a first end of the second inboard actuator and coupled to the load device at a second end of the second inboard actuator, the second inboard actuator coupled to the tongue opposite the first inboard actuator;
a second outboard actuator coupled to the fourth solid link at a first end of the second outboard actuator and coupled to the load device at a second end of the second outboard actuator, the second inboard actuator and the second outboard actuator arranged to fold a second portion of the load device toward the tongue.

17. The apparatus of claim 16, wherein the first inboard actuator and the first outboard actuator are plumbed together and operate opposite to each other, the first inboard actuator extending while the first outboard actuator contracts and the first inboard actuator contracting while the first outboard actuator extends.

18. The apparatus of claim 16, wherein the second inboard actuator and the second outboard actuator are plumbed together and operate opposite to each other, the second inboard actuator extending while the second outboard actuator contracts and the second inboard actuator contracting while the second outboard actuator extends.

19. The apparatus of claim 16, wherein the first portion of the load device is approximately parallel to the second portion of the load device when the load device is fully folded.

20. The apparatus of claim 16, wherein the first solid link and the second solid link are arranged to comprise a first stiff brace and the third solid link and the fourth solid link are arranged to comprise a second stiff brace when not folding the load device.
